(19) United States
(12) Patent Application Publication
(10) Pub. No.: US 2009/0206113 A1
(43) Pub. Date: Aug. 20, 2009

(54) Combination coat and head hanger and method of manufacturing same

(76) Inventor: Darryl Victor Lee, Greenville, NC (US)

Correspondence Address: Darryl V. Lee, PO Box 1242, Greenville, NC, 27835, US

(21) Appl. No.: 12/070,015

(22) Filed: Feb. 15, 2008

(51) Int. Cl. A41D 27/22; B23P 25/00

(52) U.S. Cl. 223/88; 29/458; 29/428

(57) ABSTRACT

A combination coat and hat hanger comprises of a jumbo plastic coat hanger. What is new in the art of the combination coat and hat hanger is a jumbo hat peg approximately six inches long with a plastic ball on one end mounted in the center of the lower portion and protruding at a 45 degree angle. The hat peg allows for a hat and a coat to be hung on the hanger simultaneously.

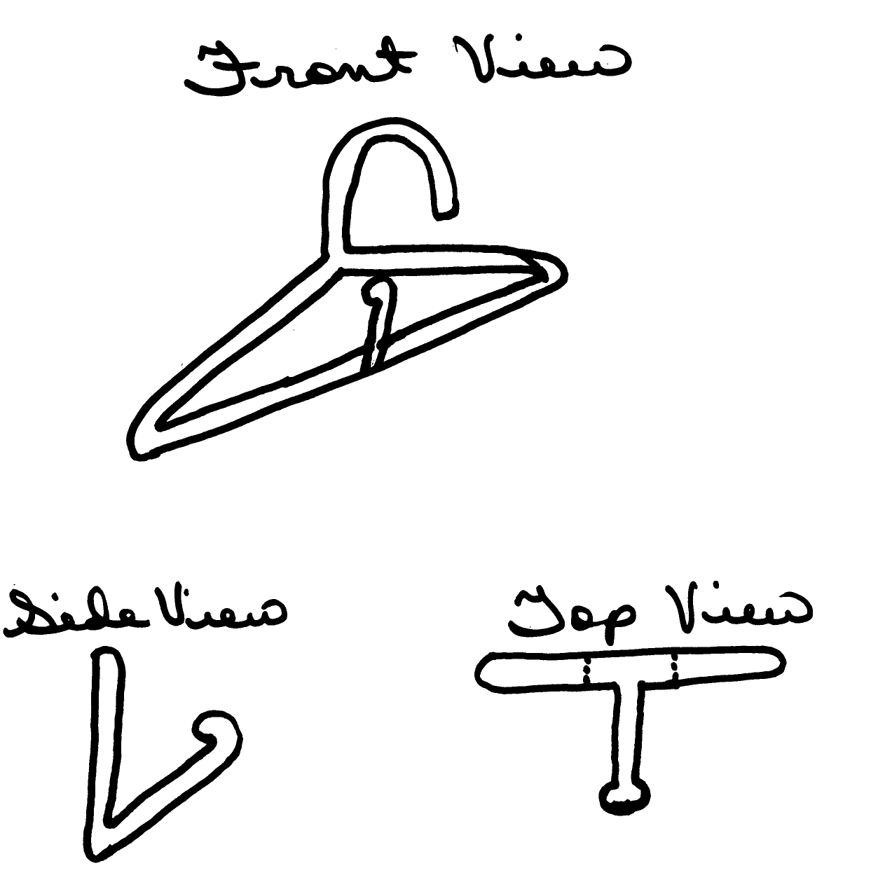

### BACKGROUND OF CLOTHES HANGERS

### Introduction

Clothes hangers have been formed from a variety of materials including wire rods, wood, combinations of materials, and plastic. Such clothes hangers include a hook portion and two inclined, diverging shoulder rails connected to and extending from the hook portion. Typically, a horizontal rail is connected between the outer ends of the shoulder rails for strength and to support pants, coats, ect. on the hanger.

Plastic hangers are formed as an integral one piece assembly, typically, by injection molding. Friction producing surfaces, such as flocking, have been previously applied to portions of hangers to prevent clothes from falling off the hangers. Typically, loose flocking fibers or particles are sprayed onto an adhesive coating previously sprayed onto the horizontal rails and or portions of the shoulder rails.

### SUMMARY OF THE INVENTION

The present invention is a combination coat and hat hanger and a method for manufacturing the same.

The hanger includes a hook portion having first and second diverging legs. A second portion is engagable with the legs of the hook portion. The second portion includes first and second inclined shoulder rails, one end of each of which is engagable with the first and second legs, respectively, of the hook portion. A horizontal rail is integrally formed with and extends between one end of each of the first and second shoulder rails.

In a preferred embodiment, the hook portion, the second portion, and the hat peg are made of plastic. Preferrably, the hook portion is injection molded and the second portion is extruded in a tubular form before the shoulder rails are bent into the desired, angular shape with respect to the planar, horizontal rail. Preferably, the hat peg portion is injection molded.

Further, a friction producing surface is optionally applied to at least portions of atleast one of the first and second shoulder rails and the horizontal rail. Preferrably, the friction producing surface comprises flocking particles or fibers which are sprayed over portions of at least one of the first and second shoulder rails and the horizontal rail.

The method of manufacturing a plastic hanger consists of:
(a) forming a hook portion having a substantially U-shaped end and first and second diverging legs,
(b) extruding a tube having first and second ends from a plastic material,
(c) bending the tube at opposite ends to form first and second inclined shoulder rails integrally connected by a planar horizontal rail,
(d) slidably engaging the first and second legs of the hook portion with the ends of the first and second rails.
(e) forming a peg portion six inches long with a ball at one end one-fourth of an inch wider than the width of the peg portion.
In a preferred embodiment, the hook portion and the peg portion is formed by injection molding the hook portion and the peg portion from a suitable plastic material.

In an optional embodiment of the method of the present invention, a friction producing surface is applied onto at least portions of at least one of the first and second shoulder rails and the horizontal rail of the hanger. Preferably, certain portions of the first and second shoulder rails or the horizontal rail are first coated by an adhesive. Flocking particles or fibers are then sprayed over the adhesive coating so as to be attached to the first and second shoulder rails and the horizontal rail by the adhesive coating. Preferably, the adhesive and the flocking fibers are sprayed onto the second portion of the hanger before the first and second shoulder rails are bent into the desired shape with respect to the horizontal rail from the elongated, extruded tube.

Also disclosed is a combination coat and hat plastic hanger having a hook portion with first and second, inclined, depending legs preparable by the method of extruding an elongated, tubular member from a plastic material having first and second ends and bending the first and second ends of the tubular member to form first and second inclined shoulder rails joined by an integral horizontal rail, the first and second ends of the shoulder rails being engagable with the first and second legs, respectively, of the hook portion. The hanger formed by this method also may be prepared by spraying flocking particles or fibers over an adhesive coating previously sprayed onto certain portions of the first and second shoulder rails and the horizontal rail.

The friction surface in the form of adhesively mounted flocking particles or fibers is applied onto the extruded tube before the shoulder rails are bent to the desired shape. This enables greater quantities of the sprayed adhesive to adhere to the hanger thereby significantly reducing waste and requiring smaller equipment and less floor space than previous methods.

I claim:

1. A method for manufacturing a hanger comprising of the steps of:
forming a hook portion having a substantially U-shaped end and first and second diverging legs;
extruding a tubular member having first and second ends from a plastic material;
bending the tubular member at opposite ends to form first and se-inclined shoulder rails integrally connected by a horizontal rail;
and slidably engaging the first and second legs of the hook portion with the ends of the first and second shoulder rails. Also forming a straight peg six inches long with a ball at one end one-fourth of an inch wider than the width of the peg.

2. The method of claim 1 further including the step of:
injection molding the hook portion from a plastic material;
injection molding the peg portion from a plastic material.

3. The method of claim 1 further including the step of:
applying a friction producing surface on at least portions of at least one of the first and second shoulder rails, the horizontal rail, and the hat peg.

4. The method of claim 3 wherein the step of applying the friction producing surface includes the steps of:
spraying at least portions of at least one of the first and second shoulder rails, the horizontal rail and the hat peg with an adhesive; and spraying flocking particles over the adhesive coating wherein the flocking particles are attached to at least portions of at least one of the first and second shoulder rails, the horizontal rail, and the hat peg by the adhesive coating.

5. The method of claim 4 wherein the steps of spraying the adhesive and spraying the flocking particles are performed before the tubular member is bent to form the first and second shoulder rails.

6. The method of claim 3 wherein the step of applying the friction producing surface includes the steps of:
spraying at least portions of certain of the first and second shoulder rails, the horizontal rail, and the hat peg with an adhesive; and winding a plurality of strands into a braid over the adhesive coating wherein the braid is adhesively attached to at least portions of at least one of the first and second shoulder rails, the horizontal rail, and the hat peg by the adhesive

7. The method of claim 6 wherein the steps of spraying the adhesive and winding the braid over the adhesive are performed before the tubular member is bent to form the first and second shoulder rails.

8. A Combination Coat and Hat Hanger including a hook portion having first and second inclined, depending legs and a peg portion having a ball at one end preparable by the process of: extruding an elongated tubular member from a plastic material having first and second ends, and bending the first and second ends of the tubular member to form first and second inclined shoulder rails joined by an integral horizontal rail, the first and second ends of the shoulder rails engagable with the first and second legs, respectively, of the peg portion.

9. The combination coat and hat hanger of claim 8 further preparable by the process of:
spraying flocking particles or fibers over an adhesive coating previously sprayed onto at least portions of at least one of the first and second shoulder rails and the horizontal rail before the first and second shoulder rails are bent in the tubular member.

10. The combination coat and hat hanger of claim 8 further preparable by the process of:
winding a plurality of strands into a braid over an adhesive coating previously sprayed onto at least portions of at least one of first and second shoulder rails and the horizontal rail before the first and second shoulder rails are bent in the tubular member.
